(19) United States
(12) Patent Application Publication
(10) Pub. No.: US 2024/0105989 A1
(43) Pub. Date: Mar. 28, 2024

(54) BATTERY

(71) Applicant: Panasonic Intellectual Property Management Co., Ltd., Osaka (JP)

(72) Inventor: YUSUKE ITO, Nara (JP)

(21) Appl. No.: 18/534,635

(22) Filed: Dec. 10, 2023

Related U.S. Application Data
(63) Continuation of application No. PCT/JP2022/018141, filed on Apr. 19, 2022.

(30) Foreign Application Priority Data
Jun. 24, 2021 (JP) 2021-104715

(51) Int. Cl. H01M 10/0562; H01M 10/052; H01M 10/058

(52) U.S. Cl. CPC H01M 10/0562; H01M 10/052; H01M 10/058

(57) ABSTRACT

A battery includes: a positive electrode layer having a positive electrode active material layer containing a positive electrode active material containing a lithium element; a negative electrode layer; a solid electrolyte layer located between the positive electrode layer and the negative electrode layer; and a reference electrode, at least a portion of the reference electrode being embedded in the solid electrolyte layer, in which the reference electrode has a metal member constituting at least part of the portion of the reference electrode embedded in the solid electrolyte layer and containing a metal which does not alloy with lithium.

### BACKGROUND

### 1. Technical Field

The present disclosure relates to a battery.

### 2. Description of the Related Art

Japanese Unexamined Patent Application Publication No. 2012-33365 discloses a reference electrode disposed between a working electrode and a counter electrode via separators, the reference electrode having a stainless-steel core and a lithium film covering the stainless-steel core.

### SUMMARY

In prior art, what is required of a battery including a solid electrolyte layer, such as an all-solid-state battery, is that in measurement of electrodes' potentials using a reference electrode, the electrode potential measurement be done stably with potential fluctuations due to environmental conditions such as temperature and passage of time being reduced.

In one general aspect, the techniques disclosed here feature a battery including: a positive electrode layer having a positive electrode active material layer containing a positive electrode active material containing a lithium element; a negative electrode layer; a solid electrolyte layer located between the positive electrode layer and the negative electrode layer; and a reference electrode, at least a portion of the reference electrode is embedded in the solid electrolyte layer, in which the reference electrode has a metal member constituting at least part of the portion of the reference electrode embedded in the solid electrolyte layer and containing a metal which does not alloy with lithium.

According to the present disclosure, the potentials of electrodes can be measured stably.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a sectional view showing a schematic configuration of a battery according to an embodiment;

FIG. 2 is a sectional view showing a schematic configuration of a battery according to the embodiment including a reference electrode in which metallic lithium is deposited on a metal wire member;

FIG. 3 is a flowchart showing an example of a method for manufacturing the battery according to the embodiment;

FIG. 4 is a sectional view showing a schematic configuration of a battery according to a modification of the embodiment;

FIG. 5 is a graph showing a charge curve regarding deposition of metallic lithium in a battery according to an example; and

FIG. 6 is a graph showing curves regarding the first charge of the battery according to the example.

### DETAILED DESCRIPTIONS

Underlying Knowledge Forming Basis of an Aspect of the Present Disclosure

An all-solid-state battery using a fire-retardant solid electrolyte, in place of an electrolyte solution containing a combustible organic solvent used in a conventional non-aqueous electrolyte lithium-ion secondary battery, is superior in terms of safety and reliability. For this reason, an all-solid-state battery is a promising next-generation battery because of its high possibility in terms of costs and energy density, such as in simplification of a safety device for the battery as a product, and its developmental race has been accelerating day by day. However, in order to put an all-solid-state battery into practical use and to achieve further improvement in its performance, further developments are needed concerning active materials for achieving high capacity and high input and output, a solid electrolyte with high ionic conductivity, building an optimal design and process, and the like. It is therefore important to have a correct understanding of the battery characteristics when developing various materials, designing combinations of those materials, and studying a manufacturing process. In particular, it is extremely useful to be able to measure the electrical characteristics of, e.g., the potential of a positive electrode and/or a negative electrode in order for the research and development to be carried out effectively and efficiently. It is also useful if the electrical characteristics of, e.g., the potential of each of the positive and negative electrodes during operation can be measured when a battery is actually used because the measurement values can be used to, e.g., control the battery more properly and make deterioration analysis in order to improve the performance such as, for example, safety and cycle characteristics.

A three-electrode measurement method using a reference electrode is known as a method for checking the potential and electrochemical behavior of each of the single electrodes. When the three-electrode measurement method using a reference electrode is used for a battery including a solid electrolyte layer such as an all-solid-state battery, the reference electrode needs to be, e.g., embedded in the solid electrolyte layer or brought into contact with the side surface of the solid electrolyte layer. However, because metallic lithium used as the reference electrode is, e.g., soft and low in stability, potentials fluctuate due to environmental conditions such as temperature and passage of time. This makes stable potential measurement difficult.

The present disclosure has been made in view of the above problem and provides a battery which includes a solid electrolyte layer, such as an all-solid-state battery, and allows electrodes' potentials to be measured stably.

The following is an overview of an aspect of the present disclosure.

A battery according to an aspect of the present disclosure includes: a positive electrode layer having a positive electrode active material layer containing a positive electrode active material containing a lithium element; a negative electrode layer; a solid electrolyte layer located between the positive electrode layer and the negative electrode layer; and a reference electrode, at least a portion of the reference electrode is embedded in the solid electrolyte layer, in which the reference electrode has a metal member constituting at least part of the portion of the reference electrode embedded in the solid electrolyte layer and containing a metal which does not alloy with lithium.

The “metal which does not alloy with lithium” may contain at least one selected from the group consisting of, for example, stainless-steel, iron, nickel, chromium, and titanium.

When the battery is used with metallic lithium being present on the surface of the metal member because, e.g., the metallic lithium is present on the surface of the metal member in advance or is deposited on the surface of the metal member using part of lithium ions released from the positive electrode layer or the like as a lithium source, the potential of each of the positive electrode layer and the negative electrode layer can be measured using the reference electrode with high accuracy. Also, because the metal member contains a metal which does not alloy with lithium, formation of an alloy with lithium is suppressed, which makes it less likely to deteriorate even after a long period of use and makes it possible to reduce fluctuations in potentials to be measured due to environmental conditions such as temperature and passage of time. Thus, when the battery according to this aspect is used, the potentials of the electrodes can be measured stably using the reference electrode.

Also, the metal which does not alloy with lithium may be, for example, stainless-steel. Compared to, e.g., nickel, which is also hard to alloy with metallic lithium like stainless-steel is, stainless-steel is soft and is less likely to bend and break when embedded into the solid electrolyte layer.

Also, the metal member may be a metal wire member having a linear shape. Also, besides the linear shape, the shape of the metal member may be a plate shape or a foil shape. When the member has a linear shape, the metal member does not easily break, and the manufacturing process becomes simpler. When the metal member has a plate shape, the site for lithium deposition increases, which increases the stability as the reference electrode. When the metal member has a foil shape, short circuit between the positive electrode layer and the negative electrode layer can be reduced more.

Also, the metal member may further include, for example, a metal layer coating the metal which does not alloy with lithium and being formed of a metal material which alloys with lithium.

This enables deposition overvoltage for depositing metallic lithium on the metal member to be decreased. As a result, the metallic lithium can be deposited on the metal member in a more even form. Thus, the potentials of the electrodes can be measured more stably using the reference electrode.

Also, the metal material may contain, for example, at least one selected from the group consisting of silver, gold, silicon, aluminum, zinc, cadmium, indium, lead, gallium, bismuth, antimony, tin, and magnesium. Also, the metal material may contain silver, for example.

This enables deposition overvoltage for depositing metallic lithium to be decreased effectively.

Also, the reference electrode may further have metallic lithium coating the metal member, for example.

This enables the potential of each of the positive electrode layer and the negative electrode layer to be measured by using the potential of the metallic lithium in the reference electrode as a reference voltage.

Also, for example, an amount of the metallic lithium and an initial charge capacity of the positive electrode active material layer may satisfy 100≤(a+b)/a≤1000, where a (mAh) is the amount of the metallic lithium, and b (mAh) is the initial charge capacity of the positive electrode active material layer.

When (a+b)/a is 100 or greater, the initial charge capacity of the positive electrode active material layer is not too small, which helps prevent the amount of lithium inserted into the negative electrode layer from falling below a design value. This helps prevent the battery characteristics from being lowered by the provision of the reference electrode. Also, when (a+b)/a is 1000 or less, a sufficient amount of lithium can be used for the reference electrode, which can reduce fluctuations in potentials due to environmental changes such as temperature and passage of time during potential measurement using the reference electrode.

Also, the metal member may be in contact with the solid electrolyte layer, for example.

Pressure is often applied in formation of each layer of the battery including the solid electrolyte layer in order to improve battery characteristics. When a reference electrode already having metallic lithium coating the metal member is used, the application of pressure tends to cause the metallic lithium to break, come off, or the like. In this regard, because the metal member is in contact with the solid electrolyte layer, metallic lithium is deposited at the interface between the metal member and the solid electrolyte layer by using part of the lithium ions released from the positive electrode layer as a lithium source. In the reference electrode thus formed, it is less likely that stress remains in the metallic lithium or that the metallic lithium breaks, comes off, or the like. The potentials of the electrodes can be measured stably because such a metal member can be used as the reference electrode.

Embodiments of the present disclosure are described with reference to the drawings.

Note that the embodiments described below each show comprehensive or specific examples. The numerical values, shapes, materials, constituents, how the constituents are disposed, positioned, and connected, steps, the order of the steps, and the like described in the embodiments below are mere examples and are not intended to limit the present disclosure. Ones of the constituents in the following embodiments that are not described in the independent claims are described as optional constituents.

Also, the drawings are schematic and are not necessarily depicted accurately. Thus, for example, there is necessarily no consistency in scale ratio between the drawings. Also, in the drawings, configurations that are substantially the same are denoted by the same reference numeral, and overlapping descriptions are omitted or simplified.

Also, the terms “above” and “below” used herein do not refer to the upward direction (up vertically) and the downward direction (down vertically) in absolute spatial recognition, but are used as terms defined by the relative positional relations based on the laminating order of a laminating structure. Also, the terms “above” and “below” are used not only when two constituents are disposed apart from each other with another constituent in between the two constituents, but also when two constituents are disposed closely to each other and are in contact with each other.

Also, a “plan view” herein is a view seen in a direction perpendicular to the main surface of the battery unless otherwise noted, such as when, e.g., it is used independently.

### Embodiment

### Configuration

First, the configuration of a battery according to an embodiment is described.

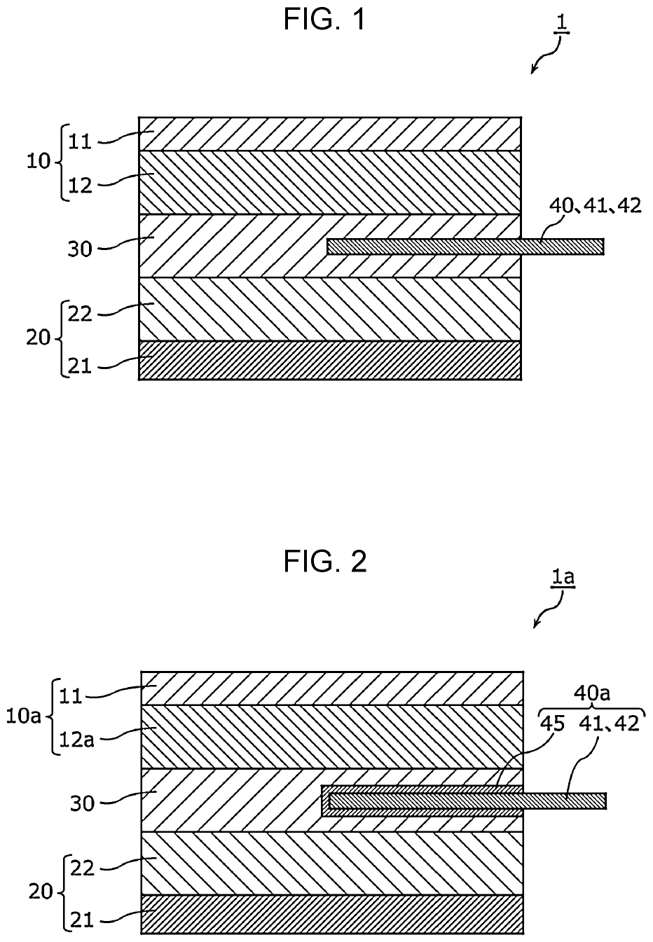

FIG. 1 is a sectional view showing a schematic configuration of the battery according to the present embodiment. A battery 1 according to the present embodiment includes a positive electrode layer 10, a negative electrode layer 20, a solid electrolyte layer 30 located between the positive electrode layer 10 and the negative electrode layer 20, and a reference electrode 40 embedded in the solid electrolyte layer 30. The battery 1 is, for example, an all-solid-state battery. Also, in the present embodiment, the battery 1 is a lithium-ion battery using lithium ions as ions that move in the solid electrolyte layer 30.

The shape of the battery 1 is, for example, a flat cuboid with its length in the laminating direction being the shortest. The shape of the battery 1 is not limited to a particular shape and may be other shapes such as a cube, a circular column, a truncated pyramid, a truncated cone, or a polygonal column. In a plan view, the battery 1 is, for example, rectangular in shape. In a plan view, the battery 1 may be in other quadrangular shapes, such as a square, a parallelogram, or a rhombus, other polygonal shapes such as a hexagon or an octagon, a circle, or an oval. Note that the thickness of each layer is exaggeratedly depicted in sectional views in FIG. 1 and the like herein in order to show the layer structure of the battery 1 in an easy-to-understand manner

The area of the main surface of the battery 1 is, for example, greater than or equal to 1 cm² and less than or equal to 100 cm². In this case, the battery 1 can be used in, for example, a mobile electronic device such as a smartphone or a digital camera. Alternatively, the area of the main surface of the battery 1 may be greater than or equal to 100 cm² and less than or equal to 1000 cm². In this case, the battery 1 can be used in, for example, a power supply for a large-scale mobile device such as an electric automobile. The “main surface” refers to the surface of the battery 1 with the largest area. The main surface of the battery 1 is, for example, a surface to which the laminating direction of the battery 1 is normal.

The positive electrode layer 10 has a positive electrode current collector 11 and a positive electrode active material layer 12. The positive electrode active material layer 12 is located between the positive electrode current collector 11 and the solid electrolyte layer 30. The negative electrode layer 20 has a negative electrode current collector 21 and a negative electrode active material layer 22. The negative electrode active material layer 22 is located between the negative electrode current collector 21 and the solid electrolyte layer 30. The positive electrode current collector 11, the positive electrode active material layer 12, the solid electrolyte layer 30, the negative electrode active material layer 22, and the negative electrode current collector 21 are laminated in this order. In a plan view, the positive electrode current collector 11, the positive electrode active material layer 12, the solid electrolyte layer 30, the negative electrode active material layer 22, and the negative electrode current collector 21 of the battery 1 have the same shape and size and coinciding outlines.

The positive electrode active material layer 12 is in contact with the main surface of the positive electrode current collector 11. Note that the positive electrode current collector 11 may include a current collector layer which is a layer containing a conductive material and provided at a portion in contact with the positive electrode active material layer 12.

The material of the positive electrode current collector 11 is not limited to a particular material, and a material typically used for batteries can be used.

Examples of the material of the positive electrode current collector 11 include copper, copper alloys, aluminum, aluminum alloys, stainless-steel, nickel, titanium, carbon, lithium, indium, and conductive resins. The shape of the positive electrode current collector 11 is not limited to a particular shape. Examples of the shape of the positive electrode current collector 11 include a foil, a film, a mesh, and a sheet. The surface of the positive electrode current collector 11 may be textured.

Note that the positive electrode layer 10 may be without the positive electrode current collector 11, and for example, a lead-out terminal, a current collector in a different battery, a connection layer to a different battery, or the like may function as a current collector of the positive electrode active material layer 12. In other words, the positive electrode layer 10 may include only the positive electrode active material layer 12 out of the positive electrode current collector 11 and the positive electrode active material layer 12.

The positive electrode active material layer 12 is located between the positive electrode current collector 11 and the solid electrolyte layer 30. The positive electrode active material layer 12 is disposed facing the negative electrode active material layer 22 with the solid electrolyte layer 30 in between.

For example, the positive electrode active material layer 12 includes at least a positive electrode active material and may also include, as needed, at least one of a solid electrolyte, a conductivity aid, or a binder material. The positive electrode active material layer 12 includes a positive electrode active material containing, for example, the lithium element. What it means by a positive electrode active material containing the lithium element is that lithium (Li) is included in a composition formula of at least one material used for the positive electrode active material. For example, the positive electrode active material contains a material having the property of occluding and releasing metallic ions such as lithium ions. Examples of the positive electrode active material include lithium- containing transition metal oxides, transition metal fluorides, polyanion materials, fluorinated polyanion materials, transition metal sulfides, transition metal oxysulfides, and transition metal oxynitrides. Examples of the lithium-containing transition metal oxides include Li(Ni, Co, Al)O₂, Li(Ni, Co, Mn)O₂, and LiCoO₂. Using a lithium-containing transition metal oxide as the positive electrode active material can especially reduce manufacturing costs and increase average discharge voltage. The positive electrode active material may contain nickel-cobalt lithium manganate to increase the energy density of the battery. The positive electrode active material may be, for example, Li(Ni, Co, Mn)O₂.

As the solid electrolyte contained in the positive electrode active material layer 12, a solid electrolyte which will be described later as an example of a solid electrolyte contained in the solid electrolyte layer 30 may be used.

The negative electrode active material layer 22 is in contact with the main surface of the negative electrode current collector 21. Note that the negative electrode current collector 21 may include a current collector layer which is a layer containing a conductive material and provided at a portion in contact with the negative electrode active material layer 22.

The material of the negative electrode current collector 21 is not limited to a particular material, and a material typically used or batteries can be used. Examples of the material of the negative electrode current collector 21 include metal materials such as stainless-steel, nickel, copper, and alloys of these metals. Copper and copper alloys are inexpensive and easy to be formed thinly. Examples of the shape of the negative electrode current collector 21 include a foil, a film, a mesh, and a sheet. The surface of the negative electrode current collector 21 may be textured.

Note that the negative electrode layer 20 may be without the negative electrode current collector 21, and for example, a lead-out terminal, a current collector in a different battery, a connection layer to a different battery, or the like may function as a current collector of the negative electrode active material layer 22. In other words, the negative electrode layer 20 may include only the negative electrode active material layer 22 out of the negative electrode current collector 21 and the negative electrode active material layer 22.

The thickness of each of the positive electrode current collector 11 and the negative electrode current collector 21 is, for example, greater than or equal to 1 μm and less than or equal to 30 μm. When the positive electrode current collector 11 and the negative electrode current collector 21 are 1 μm or greater in thickness, sufficient mechanical strength can be offered. Also, when the positive electrode current collector 11 and the negative electrode current collector 21 are less than or equal to 30 μm in thickness, the energy density of the battery is less likely to decrease.

The negative electrode active material layer 22 is located between the negative electrode current collector 21 and the solid electrolyte layer 30. For example, the negative electrode active material layer 22 includes at least a negative electrode active material and may also include, as needed, at least one of a solid electrolyte, a conductivity aid, or a binder material. For example, the negative electrode active material contains a material that occludes and releases lithium ions. Examples of the negative electrode active material include metallic lithium, metals or alloys that exhibit an alloying reaction with lithium, carbon, transition metal oxides, and transition metal sulfides. Examples of the carbon include graphite and non-graphite carbon such as hard carbon and coke. Examples of the transition metal oxides include TiO, CuO, NiO, and SnO. Examples of the transition metal sulfides include copper sulfide expressed as CuS. Examples of the metals or alloys that exhibit an alloying reaction with lithium include silicon compounds, tin compounds, aluminum compounds, and alloys of lithium. Using carbon as the negative electrode active material can lower manufacturing costs and increase average discharge voltage. From the perspective of capacity density, the negative electrode active material may be silicon (Si), tin (Sn), a silicon compound, or a tin compound.

As the solid electrolyte contained in the negative electrode active material layer 22, a solid electrolyte which will be described later as an example of a solid electrolyte contained in the solid electrolyte layer 30 may be used.

The solid electrolyte layer 30 is disposed between the positive electrode active material layer 12 and the negative electrode active material layer 22. The solid electrolyte layer 30 is in contact with both the positive electrode active material layer 12 and the negative electrode active material layer 22.

The solid electrolyte layer 30 includes at least a solid electrolyte and may also include a binder material as needed. A solid electrolyte conducts lithium ions. Examples of the solid electrolyte used in the solid electrolyte layer 30 include sulfide solid electrolytes, oxide solid electrolytes, halide solid electrolytes, polymeric solid electrolytes, and complex hydride solid electrolytes.

Examples of the sulfide solid electrolytes include Li₂S-P₂S₅, Li₂S-SiS₂, Li₂S-B₂S₃, Li₂S-GeS₂, Li_{3.25}Ge_{0.25}P_{0.75}S₄, and Li₁₀GeP₂S₁₂. Also, LiX (X is one of F, Cl, Br, and I), Li₂O, MOₚ, Li_{q}MOᵣ (M is one of P, Si, Ge, B, Al, Ga, In, Fe, and Zn, and p, q, and r are natural numbers) may be added to the above.

Examples of the oxide solid electrolytes include NASICON solid electrolytes typified by LiTi₂(PO₄))₃ and its element substitution products, (LaLi)TiO₃-based perovskite solid electrolytes, LISICON solid electrolytes typified by Li₁₄ZnGe₄O₁₆, Li₄SiO₄, LiGeO₄, and their element substitution products, garnet-type solid electrolytes typified by Li₇La₃Zr₂O₁₂ and its element substitution products, Li₃ N or its H substitution products, Li₃PO₄ or its N substitution products, and glasses and glass-ceramics produced by adding Li₂SO₄, Li₂CO₃, or the like to a base a Li—B—O compound such as LiBO₂ or Li₃BO₃.

Examples of the halide solid electrolytes include a material expressed by a composition formula Li_{α}M_{β}X_{γ} where α, β, and γ are values greater than zero, M contains at least one of a metal element other than Li or a semimetal element, and X is one or more elements selected from the group consisting of Cl, Br, I, and F. Here, the semimetal element is B, Si, Ge, As, Sb, or Te. The metal element is all the elements included in the 1st to 12th groups in the periodic table excluding hydrogen and all the elements included in the 13th to 16th groups excluding the above-described semimetal elements and C, N, P, O, S, and Se. These are, in other words, a group of elements that can become cations when forming an inorganic compound with a halide compound. Examples of the halide solid electrolytes include Li₃YX₆, Li₂MgX₄, Li₂FeX₄, Li(Al, Ga, In)X₄, and Li₃(Al, Ga, In)X₆ (X is one of F, Cl, Br, and I).

Examples of the complex hydride solid electrolytes include LiBH₄-LiI and LiBH₄-P₂S₅.

Examples of the polymeric solid electrolytes include a compound of a polymeric compound and lithium salt. The polymeric compound may have an ethylene oxide structure. When the polymeric compound has an ethylene oxide structure, the compound can contain a large amount of lithium salt, which contributes to higher ion conductivity. Examples of the lithium salt include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. As the lithium salt, one selected from the above may be used solely, or a mixture of two or more lithium salts selected from the above may be used.

The thickness of the solid electrolyte layer 30 is, for example, greater than or equal to 150 μm and less than or equal to 1000 μm.

The reference electrode 40 is at least partially embedded in the solid electrolyte layer 30 and in contact with the solid electrolyte layer 30. The reference electrode 40 is spaced apart from each of the positive electrode layer 10 and the negative electrode layer 20 with the solid electrolyte layer 30 in between. In other words, the reference electrode 40 is in contact with neither the positive electrode layer 10 nor the negative electrode layer 20.

For example, the reference electrode 40 extends from a side surface of the solid electrolyte layer 30 toward the inside of the solid electrolyte layer 30. In the present embodiment, the reference electrode 40 is partially embedded in the solid electrolyte layer 30. Note that the reference electrode 40 may instead be embedded entirely in the solid electrolyte layer 30 and connected to, e.g., a lead wire with an insulation coating extending to the outside of the battery 1.

The disposition of the reference electrode 40 within the solid electrolyte layer 30 is not limited to particular disposition as long as the reference electrode 40 is disposed apart from the positive electrode layer 10 and the negative electrode layer 20. For example, the reference electrode 40 is disposed in parallel to the positive electrode layer 10 and the negative electrode layer 20. The tip of the reference electrode 40 located inside the solid electrolyte layer 30 is located at, for example, a center part of the solid electrolyte layer 30. In other words, the reference electrode 40 extends from the side surface of the solid electrolyte layer 30 to a center portion of the solid electrolyte layer 30. In a sectional view, the length of the portion of the reference electrode 40 which is embedded in the solid electrolyte layer 30 is, for example, half or more of the width of the solid electrolyte layer 30.

The reference electrode 40 has a metal wire member 41. In the example shown in FIG. 1, the reference electrode 40 is formed by the metal wire member 41. The metal wire member 41 is embedded in the solid electrolyte layer 30. The metal wire member 41 is in contact with the solid electrolyte layer 30. For example, the metal wire member 41 is in contact with the solid electrolyte layer 30 over its entire surface of its portion embedded in the solid electrolyte layer 30. There is no other material interposed between the metal wire member 41 and the solid electrolyte layer 30.

The metal wire member 41 is a wire-shaped member formed of a metal material. For example, the metal member constituting the metal wire member 41 does not contain a lithium component. The sectional shape of the metal wire member 41 is, for example, circular, but may be an oval or a non-circular shape such as a square, a rectangle, or a polygon. The metal wire member 41 is in contact with the solid electrolyte layer 30. For example, the metal wire member 41 is a member such that, at a stage prior to the first charge between the positive electrode layer 10 and the negative electrode layer 20, metallic lithium can be deposited on its surface by using part of lithium ions released from the positive electrode active material layer 12 as a lithium source. There is no metallic lithium on the surface of the metal wire member 41 in the reference electrode 40. In the battery 1, depositing metallic lithium on the surface of the metal wire member 41 enables the reference electrode 40 to be used to measure the potential of each of the positive electrode layer 10 and the negative electrode layer 20.

When the sectional shape of the metal wire member 41 is circular, the diameter of the metal wire member 41 (i.e., the length in a direction orthogonal to the longitudinal direction of the metal wire member 41) is, for example, greater than or equal to 100 μm and less than or equal to 500 μm. When the metal wire member 41 is 100 μm or greater in diameter, breakage such as disconnection is less likely to occur. Also, when the diameter of the metal wire member 41 is 500 μm or less, the region in the solid electrolyte layer 30 occupied by the reference electrode 40 is not too large, and ion conduction by the solid electrolyte layer 30 is hindered less. Note that when the sectional shape of the metal wire member 41 is not circular, for example, the shortest one of the lengths orthogonal to the longitudinal direction of the metal wire member 41 is 100 μm or greater, and the longest one of the lengths orthogonal to the longitudinal direction of the metal wire member 41 is 500 μm or less.

In the present embodiment, the metal wire member 41 is formed by a stainless-steel wire 42. Thus, the descriptions for the position, size, and the like of the metal wire member 41 in the present embodiment also apply to the stainless-steel wire 42.

The stainless-steel wire 42 forms at least part of the portion of the reference electrode 40 which is embedded in the solid electrolyte layer 30. In the battery 1, the portion of the reference electrode 40 which is embedded in the solid electrolyte layer 30 is formed of the stainless-steel wire 42.

The stainless-steel wire 42 is a wire made of stainless-steel. Because stainless-steel is hard to f alloy with metallic lithium, the stainless-steel wire 42 is less likely to deteriorate even if metallic lithium is deposited on the surface of the metal wire member 41 including the stainless-steel wire 42. For this reason, potential measurement results for the positive electrode layer 10 and the negative electrode layer 20 obtained using the reference electrode 40 do not change due to environmental conditions such as temperature or passage of time, which enables stable measurement of electrodes' potentials. Also, compared to nickel or the like, which is also hard to alloy with metallic lithium like stainless-steel is, stainless-steel is soft and is less likely to bend and break when embedded into the solid electrolyte layer 30. Thus, in the battery 1, electrodes' potentials can be measured stably. Also, stainless-steel requires relatively low deposition overvoltage for depositing metallic lithium and therefore makes it easier for metallic lithium to be deposited on the surface of the metal wire member 41 evenly.

In this way, in the battery 1, metallic lithium is deposited on the surface of the metal wire member 41 to make it possible to measure the potential of each of the positive electrode layer 10 and the negative electrode layer 20. FIG. 2 is a sectional view showing a schematic configuration of a battery according to the present embodiment including a reference electrode having metallic lithium deposited on the metal wire member.

As shown in FIG. 2, a battery 1a has a configuration such that metallic lithium 45 is deposited on the surface of the metal wire member 41 of the battery 1. Specifically, the battery la is formed when in the battery 1, part of lithium ions released from the positive electrode active material layer 12 is used as a lithium source to deposit the metallic lithium 45 on the surface of the metal wire member 41 at a stage prior to the first charge between the positive electrode layer 10 and the negative electrode layer 20.

The battery 1a includes a positive electrode layer 10a, the negative electrode layer 20, the solid electrolyte layer 30, and a reference electrode 40a. The positive electrode layer 10a has the positive electrode current collector 11 and a positive electrode active material layer 12a. The positive electrode layer 10a has the same configuration as the positive electrode layer 10 except for having the positive electrode active material layer 12a which is the positive electrode active material layer 12 in which part of the lithium source has been used to deposit the metallic lithium 45.

The reference electrode 40a has the metal wire member 41 and the metallic lithium 45 coating the metal wire member 41. Part of the reference electrode 40a is embedded in the solid electrolyte layer 30.

The metallic lithium 45 is, for example, a lithium film deposited on the surface of the metal wire member 41. The metallic lithium 45 coats the surface of the portion of the metal wire member 41 which is embedded in the solid electrolyte layer 30. The metallic lithium 45 is located between the metal wire member 41 and the solid electrolyte layer 30. For example, the metallic lithium 45 coats the entire surface of the portion of the metal wire member 41 which is embedded in the solid electrolyte layer 30. Alternatively, the metallic lithium 45 may coat part of the surface. The metallic lithium 45 is in contact with both the metal wire member 41 and the solid electrolyte layer 30. Also, the metallic lithium 45 is apart from the positive electrode layer 10 and the negative electrode layer 20 with the solid electrolyte layer 30 in between. In other words, the metallic lithium 45 is in contact with neither the positive electrode layer 10 nor the negative electrode layer 20. Note that part of the metallic lithium 45 may penetrate into the metal wire member 41.

In the battery la, the portion of the reference electrode 40a which is embedded in the solid electrolyte layer 30 is formed by the stainless-steel wire 42 and the metallic lithium 45.

The amount of the metallic lithium 45 and the initial charge capacity of the positive electrode active material layer 12a satisfy, for example, 100≤(a+b)/a≤1000, where a (mAh) is the amount of the metallic lithium 45 and b (mAh) is the initial charge capacity of the positive electrode active material layer 12a. When (a+b)/a is 100 or greater, the initial charge capacity of the positive electrode active material layer 12a is not too small, which makes it less likely for the amount of lithium inserted into the negative electrode active material layer 22 to fall below a design value. For this reason, degradation of battery characteristics due to provision of the reference electrode 40a can be reduced. Also, when (a+b)/a is 1000 or less, a sufficient amount of lithium can be used for the reference electrode 40a, which can reduce fluctuations in potential due to environmental changes such as temperature and passage of time during potential measurement using the reference electrode 40a. Note that “a” above is a value obtained by converting the amount of the metallic lithium 45 into the amount of charges for ionization of all the metallic lithium. The initial charge capacity of the positive electrode active material layer 12a is the charge capacity measured at the time of, for example, the first charge. Also, the initial charge capacity of the positive electrode active material layer 12a is equal to the theoretical capacity of the positive electrode active material layer 12a. Thus, the initial charge capacity of the positive electrode active material layer 12a can be determined also by the type and amount of the positive electrode active material contained in the positive electrode active material layer 12a.

As thus described, the battery 1 of the present embodiment includes the positive electrode layer 10, the negative electrode layer 20, and the reference electrode 40 which is at least partially embedded in the solid electrolyte layer 30 and which has the metal wire member 41 including the stainless-steel wire 42.

Thus, like in the battery 1a, the metallic lithium 45 can be deposited on the metal wire member 41 by using lithium ions released from the positive electrode active material layer 12 as a lithium source, and the reference electrode 40a having the metal wire member 41 which has deposition of the metallic lithium 45 on its surface can be used to measure the potential of each of the positive electrode layer 10 and the negative electrode layer 20 with high accuracy. Also, including the stainless-steel wire 42, the metal wire member 41 is hard to alloy with lithium and less likely to deteriorate even after a long period of use, and thus, fluctuations in potentials to be measured due to environmental conditions and passage of time can be reduced. Thus, the potential of each of the positive electrode layer 10 and the negative electrode layer 20 can be measured stably using the reference electrode 40a.

### Manufacturing Method

Next, a method for manufacturing the battery according to the present embodiment is described. The following describes a method for manufacturing the battery la described above. It should be noted that the method for manufacturing the battery of the present embodiment is not limited to the example described below.

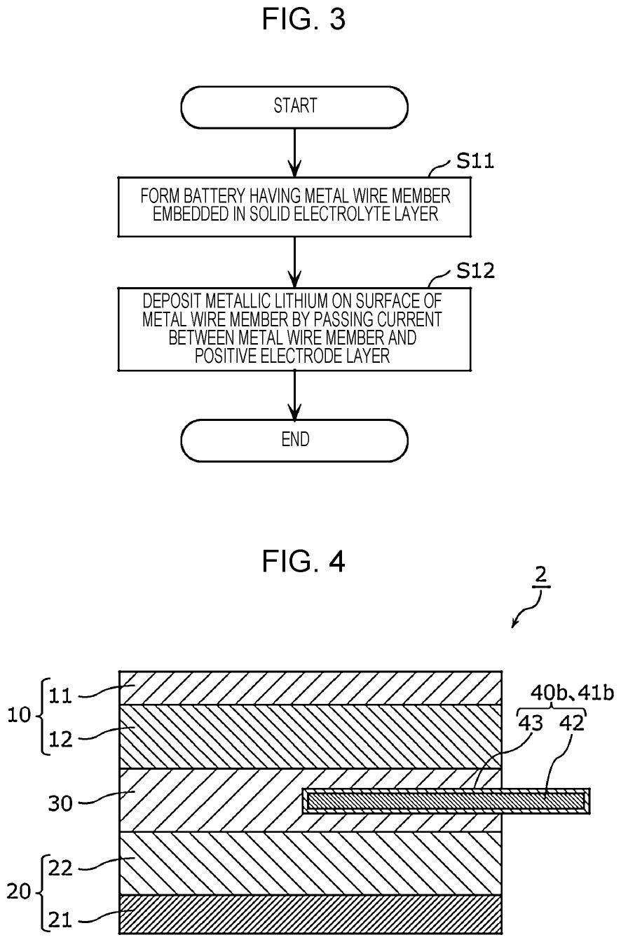

FIG. 3 is a flowchart showing an example of a method for manufacturing the battery la according to the present embodiment.

As shown in FIG. 3, in the method for manufacturing the battery 1a, first, the battery 1 in which the metal wire member 41 is embedded in the solid electrolyte layer 30 is formed (Step S11). Specifically, first, a material for the solid electrolyte layer 30 is applied onto a base material and is pressurized, heated, or the like as needed to form a layer to be a part of the solid electrolyte layer 30. The metal wire member 41 is disposed on one of the surfaces of the layer thus formed, and a material for the solid electrolyte layer 30 is further applied on top of that, and is pressurized, heated, or the like as needed to form the solid electrolyte layer 30 in which the metal wire member 41 is embedded.

Then, a material for the positive electrode active material layer 12 is applied to one of the surfaces of the positive electrode current collector 11 and is pressurized, heated, or the like as needed to form the positive electrode layer 10. Next, a material for the negative electrode active material layer 22 is applied to one of the surfaces of the negative electrode current collector 21 and is pressurized, heated, or the like as needed to form the negative electrode layer 20.

The positive electrode layer 10, the negative electrode layer 20, and the solid electrolyte layer 30 thus formed are laminated so that the positive electrode active material layer 12 and the negative electrode active material layer 22 may face each other with the solid electrolyte layer 30 in between and be in contact with the solid electrolyte layer 30, and are pressurized in the laminating direction. The battery 1 shown in FIG. 1 is thus formed.

Note that the method for forming the battery 1 is not limited to the method described above, and various publicly known battery manufacturing methods may be employed. For example, the battery 1 may be formed as follows. A positive electrode plate formed by laminating the positive electrode current collector 11, the positive electrode active material layer 12, and the solid electrolyte layer 30 in this order is prepared, and a negative electrode plate obtained by laminating the negative electrode current collector 21, the negative electrode active material layer 22, and the solid electrolyte layer 30 in this order is prepared. Then, the positive electrode plate and the negative electrode plate are joined together in such a manner that the metal wire member 41 is sandwiched by the solid electrolyte layers 30, i.e., with the solid electrolyte layers 30 in between. Alternatively, the battery 1 may be formed by forming a battery in which the metal wire member 41 is not embedded and then inserting the metal wire member 41 from the side surface of the solid electrolyte layer 30. Also, each layer of the battery 1 may be formed by filling an insulating die with a material for the layer.

Next, in the method for manufacturing the battery 1a, current is passed between the metal wire member 41 and the positive electrode layer 10 to deposit the metallic lithium 45 on the surface of the metal wire member 41 (Step S12). For example, lead wires or the like are connected to the metal wire member 41 and to the positive electrode current collector 11 of the positive electrode layer 10, and current is passed from the metal wire member 41 to the positive electrode layer 10 to perform charge between the metal wire member 41 and the positive electrode layer 10. As a result of this, the metallic lithium 45 is deposited on the surface of the metal wire member 41 using lithium ions released from the positive electrode active material layer 12 as a lithium source. Because the metal wire member 41 of the reference electrode 40 is in contact with the solid electrolyte layer 30, the metallic lithium 45 is deposited at the interface between the metal wire member 41 and the solid electrolyte layer 30. As a result, the reference electrode 40a is fabricated, and the battery 1a shown in FIG. 2 is manufactured.

For example, Step S12 is carried out before no charge has been performed between the positive electrode layer 10 and the negative electrode layer 20. Alternatively, Step S12 may be carried out after charge/discharge is performed one or more times between the positive electrode layer 10 and the negative electrode layer 20.

In Step S12, the amount of the metallic lithium 45 deposited and the initial charge capacity of the positive electrode active material layer 12 satisfy, for example, 100≤c/a≤1000, where a (mAh) is the amount of the metallic lithium 45 deposited and c (mAh) is the initial charge capacity of the positive electrode active material layer 12. When c/a is 100 or greater, a lithium source from the positive electrode active material layer 12 is not too much, which helps prevent the amount of lithium inserted into the negative electrode active material layer 22 when the battery la is used from falling below a design value. Thus, degradation of the battery characteristics due to the formation of the reference electrode 40a can be reduced. Also, when c/a is 1000 or less, a sufficient amount of lithium is used for the reference electrode 40a, which can reduce fluctuations in potential due to environmental changes such as temperature and passage of time during potential measurement using the reference electrode 40a. The initial charge capacity of the positive electrode active material layer 12 is the charge capacity measured at the time of, for example, the first charge. Also, the initial charge capacity of the positive electrode active material layer 12 is equal to the theoretical capacity of the positive electrode active material layer 12. Thus, the initial charge capacity of the positive electrode active material layer 12 can be determined also by the type and amount of the positive electrode active material contained in the positive electrode active material layer 12.

The amount of the metallic lithium 45 deposited corresponds to the amount of charges of the current passed between the metal wire member 41 and the positive electrode layer 10 during charge. Thus, the amount of the metallic lithium 45 is controlled by the amount of current passed between the metal wire member 41 and the positive electrode layer 10. Also, the initial charge capacity of the positive electrode active material layer 12 is equal to the theoretical capacity of the positive electrode active material layer 12. Thus, the initial charge capacity of the positive electrode active material layer 12 can be controlled by the type and amount of the positive electrode active material contained in the positive electrode active material layer 12. Also, because the metallic lithium 45 uses lithium ions released from the positive electrode active material layer 12 as a lithium source, the total of the amount of the metallic lithium 45 and the initial charge capacity of the positive electrode active material layer 12a after the above-described deposition of the metallic lithium 45 is the initial charge capacity of the positive electrode active material layer 12. In other words, a+b=c.

Because the lithium source for the metallic lithium 45 comes from the positive electrode active material layer 12, deposition of the metallic lithium 45 tends to concentrate more on the surface of the metal wire member 41 on the positive electrode layer 10 side than on the surface of the metal wire member 41 on the negative electrode layer 20 side. This tendency is notable particularly because lithium ions being a lithium source move in the solid electrolyte layer 30 from the positive electrode active material layer 12 toward the metal wire member 41. The deposition location of the metallic lithium 45 and the form of the metallic lithium 45 are controlled by, for example, adjustment of at least one of the following charge conditions: temperature or current rate. The current rate in relation to the theoretical capacity of the positive electrode active material during charge is, for example, greater than or equal to 0.001 C and less than or equal to 0.01 C. Temperature during charge is, for example, greater than or equal to 25° C. and less than or equal to 80° C. When charge is performed under such current rate and temperature, the metallic lithium 45 can be more easily formed over the entire surface of the metal wire member 41 with an even thickness. As a result, the potential of each of the positive electrode layer 10 and the negative electrode layer 20 can be measured stably using the reference electrode 4a.

As stated above, the method for manufacturing the battery la fabricates the reference electrode 40a by, for example, passing current between the metal wire member 41 and the positive electrode layer 10 to deposit the metallic lithium 45 on the surface of the metal wire member 41. In an all-solid-state battery like the battery 1a, pressure is often applied in formation of each layer of the battery la in order to improve battery characteristics. When a reference electrode already having metallic lithium coating the metal wire member 41 is used, the application of pressure tends to cause the metallic lithium to break, come off, or the like. By contrast, in the method for manufacturing the battery la, the metal wire member 41 has not been coated by the metallic lithium 45 yet when the positive electrode layer 10, the negative electrode layer 20, and the solid electrolyte layer 30 of the battery la are formed, and therefore, breaking or coming off of the metallic lithium 45 does not occur. Thus, in manufacturing of the battery 1a, it is less likely that stress remains in the metallic lithium 45 or the metallic lithium 45 breaks, comes off, or the like, compared to a case where a reference electrode is embedded with metallic lithium already coating the metal wire member 41. Thus, the quality of the metallic lithium 45 and the state of contact between the metallic lithium 45 and the metal wire member 41 are less likely to change due to a long period of use and temperature change during use. Thus, the potential of each of the positive electrode layer 10 and the negative electrode layer 20 can be measured stably using the reference electrode 40a.

### Modification

Next, a modification of the embodiment is described. The description of the modification below mainly describes differences from the embodiment and omits or simplifies descriptions of points in common.

FIG. 4 is a sectional view showing a schematic configuration of a battery according to the present modification. As shown in FIG. 4, a battery 2 according to the present modification differs from the battery 1 according to the embodiment in including a reference electrode 40b in place of the reference electrode 40.

The reference electrode 40b has a metal wire member 41b. In the example shown in FIG. 4, the reference electrode 40b is formed by the metal wire member 41b. The reference electrode 40b is embedded in the solid electrolyte layer 30.

The metal wire member 41b includes not only the stainless-steel wire 42 of the metal wire member 41 according to the embodiment, but also a metal layer 43 coating the stainless-steel wire 42. In the present modification, the stainless-steel wire 42 constitutes part of the portion of the reference electrode 40b which is embedded in the solid electrolyte layer 30.

For example, the metal layer 43 coats the entire surface of the stainless-steel wire 42. The metal layer 43 is in contact with both the stainless-steel wire 42 and the solid electrolyte layer 30. Note that the metal layer 43 may coat part of the surface of the stainless-steel wire 42. For example, the metal layer 43 may coat only the radially outer circumferential surface of the stainless-steel wire 42 out of the entire surface of the stainless-steel wire 42, or may coat only the surface of the portion of the stainless-steel wire 42 which is embedded in the solid electrolyte layer 30.

The metal layer 43 is formed of a metal material which alloys with lithium. A metal material which alloys with lithium refers to a metal material which progressively alloys with lithium when brought into contact with lithium at normal temperatures. When the metal wire member 41b includes the metal layer 43, deposition overvoltage for depositing metallic lithium on the metal wire member 41b can be decreased. This allows the metallic lithium to be deposited on the metal wire member 41b in a more even deposition form.

For example, the metal material includes at least one selected from the group consisting of gold (Au), silicon (Si), aluminum (Al), zinc (Zn), cadmium (Cd), indium (In), lead (Pb), gallium (Ga), bismuth (Bi), antimony (Sb), tin (Sn), silver (Ag), and magnesium (Mg). This enables overvoltage for depositing metallic lithium to be decreased effectively. The metal material is formed of, for example, a metal formed of one selected from the above-described group, an alloy containing one selected from the above-described group as a main component, or an alloy formed of two or more selected from the above-described group. The metal material may contain a metal not included in the above-described group or a non-metal. From the perspective of effectively reducing the activation energy for deposition of metallic lithium and decreasing the overvoltage for the deposition even more, the metal material may contain silver, may be formed of silver, or may be formed of an alloy containing silver as a main component.

The thickness of the metal layer 43 is, for example, greater than or equal to 10 nm and less than or equal to 100 nm. When the thickness of the metal layer 43 is in this range, deposition overvoltage for depositing metallic lithium can be decreased, and at the same time, a sufficient amount of metallic lithium can be deposited on the surface of the metal wire member 41b.

The metal layer 43 is formed by, for example, forming a film of the metal material on the stainless-steel wire 42 which has yet to be embedded in the solid electrolyte layer 30, using a publicly known thin-film formation process such as the vacuum deposition method.

In the battery 2, metallic lithium is deposited on the surface of the metal wire member 41b using the same method as the battery 1, so that the potential of each of the positive electrode layer 10 and the negative electrode layer 20 can be measured. Thus, the potential of each of the positive electrode layer 10 and the negative electrode layer 20 can be measured stably with the battery 2 as well.

### EXAMPLE

Details of the present disclosure are described below using an example. The following example is merely an example, and the present disclosure is not limited to the example below. The fabrication of a solid electrolyte, a positive electrode active material layer, a negative electrode active material layer, and a battery described below was all done inside a glovebox at a dew point of −60° C. or below in an argon atmosphere.

### Fabrication of the Solid Electrolyte

Li₂S and P₂S₅ were weighed to be Li₂S:P₂S₅=75:25 in mole ratio. They were pounded in a mortar and mixed together. Then, a planetary ball mill (manufactured by Fritsch Japan Co., Ltd, model P-7) was used to perform milling at 510 rpm for ten hours, and glass solid electrolyte was thereby obtained. The glass solid electrolyte was thermally treated in an inert atmosphere at 270° C. for two hours. Li₂S-P₂S₅, which is glass-ceramics solid electrolyte, was thereby obtained.

### Fabrication of the Positive Electrode Active Material Layer

The solid electrolyte obtained above and Li(NiCoMn)O₂ (hereinafter referred to as NCM) as a positive electrode active material were weighed to be 30:70 in volume ratio. They were mixed together in an agate mortar to fabricate a positive electrode material. Next, the positive electrode material was applied to a base material and pressurized to obtain a positive electrode active material layer.

### Fabrication of the Negative Electrode Active Material Layer

The solid electrolyte obtained above and Li₄Ti₅O₁₂ (hereinafter referred to as LTO) as a negative electrode active material were weighed to be 40:60 in volume ratio. They were mixed together in an agate mortar to fabricate a negative electrode material. Next, the negative electrode material was applied to a base material and pressurized to obtain a negative electrode active material layer.

### Fabrication of the Battery

The following steps were carried out using the solid electrolyte, the positive electrode active material layer, and the negative electrode active material layer obtained above. First, 40 mg of the solid electrolyte was weighed out, put into an insulating cylinder whose inner diameter portion had a sectional area of 0.7 cm², and subjected to pressure shaping under 50 MPa. Next, a stainless-steel wire with a 250 μm diameter was disposed on one of the surfaces of the pressure-shaped solid electrolyte, in such a manner as to extend across the insulating cylinder. Then, 40 mg of the solid electrolyte was added to cover the stainless-steel wire, and pressure shaping was performed under 50 MPa. A solid electrolyte layer having the stainless-steel wire embedded therein was thereby formed.

Next, a piece punched out from the positive electrode active material layer into the size of the inner diameter portion of the insulating cylinder was disposed in contact with one of the surfaces of the solid electrolyte layer, and a piece punched out from the negative electrode active material layer into the size of the inner diameter portion of the insulating cylinder was disposed in contact with the other one of the surfaces of the solid electrolyte layer which is opposite from the side in which the positive electrode active material layer was in contact. The resultant product was subjected to pressure shaping under 600 MPa to fabricate a laminating structure formed by the positive electrode active material layer, the negative electrode active material layer, the solid electrolyte layer, and the stainless-steel wire.

Next, two stainless-steel current collectors were disposed on the top and bottom of the laminating structure as a positive electrode current collector to come into contact with the positive electrode active material layer and a negative electrode current collector to come into contact with the negative electrode active material layer, and lead wires were attached to the respective current collectors. Lastly, an insulating ferrule was used to shield and seal the inside of the insulating cylinder from the outside atmosphere, and the battery according to the example was thereby fabricated. The theoretical capacity of the positive electrode active material layer of the battery thus fabricated was 2.5 mAh. Hereinbelow, the positive electrode active material layer and the positive electrode current collector may be collectively referred to as a positive electrode, and the negative electrode active material layer and the negative electrode current collector may be collectively referred to as a negative electrode. Also, the stainless-steel wire may be referred to as a reference electrode.

Also, a voltage measurement instrument was set to measure the voltage between the positive electrode and the negative electrode, between the positive electrode and the reference electrode, and between the negative electrode and the reference electrode of the battery fabricated.

### Checking Metallic Lithium Deposition and Charge Characteristics

The lead wire attached to the negative electrode current collector of the battery fabricated was detached and connected to the stainless-steel wire, and charge was performed at 60° C. for 10 hours with a current value of 2.5 μA at a rate of 0.001 C (i.e., a 1000-hour rate) in relation to the theoretical capacity of the positive electrode active material layer, thereby depositing metallic lithium on the stainless-steel wire. As a result, metallic lithium corresponding to 0.025 mAh was deposited on the stainless-steel wire. Because a+b is the theoretical capacity of the positive electrode active material layer before the metallic lithium deposition, (a+b)/a=100 holds true, where a (mAh) is the amount of metallic lithium deposited on the stainless-steel wire, and b (mAh) is the initial charge capacity of the positive electrode active material layer after the metallic lithium deposition.

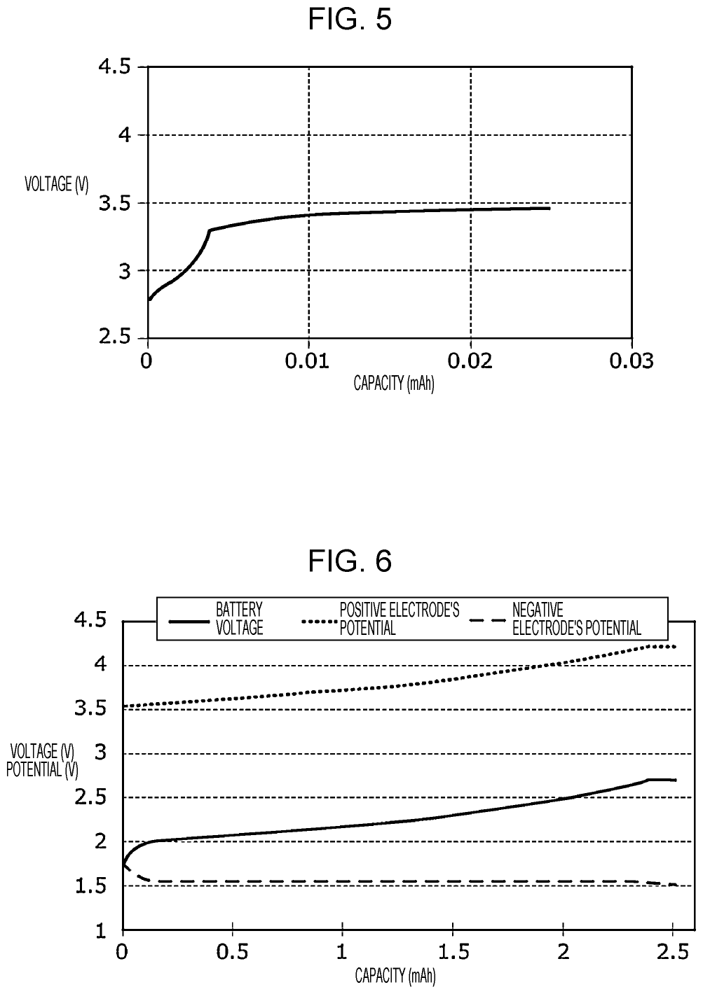

FIG. 5 is a diagram showing a charge curve regarding deposition of metallic lithium was deposited in the battery according to the example. FIG. 5 shows a change in voltage (the vertical axis) between the positive electrode and the reference electrode in relation to the amount of current charged (the horizontal axis). As shown in FIG. 5, the voltage between the positive electrode and the reference electrode when charge was performed was almost constant and stable, and the potential of the positive electrode on the basis of the reference electrode was measured. Thus, this shows that performing charge under the condition (a+b)/a=100 formed the reference electrode formed by the stainless-steel wire coated with metallic lithium inside the solid electrolyte layer as a result of deposition of metallic lithium on the stainless-steel wire with a lithium source being lithium ions released from the positive electrode active material layer.

Next, the lead wire connected to the stainless-steel wire was connected back to the negative electrode current collector, and charge was performed at 25° C. with a current value of 0.25 mA at a rate of 0.05 C (i.e., a 20-hour rate) in relation to the theoretical capacity of the positive electrode active material layer until the potential of the negative electrode on the basis of the positive electrode, i.e., the battery voltage, reaches 2.7 V. The characteristics of the first charge were then checked.

FIG. 6 is a diagram showing curves regarding the first charge of the battery according to the example. FIG. 6 shows changes in the battery voltage and in the potentials of the positive and negative electrodes (the vertical axis) on the basis of the potential of the metallic lithium, in relation to the amount of current charged (the horizontal axis). As shown in FIG. 6, in the first charge process, plateaus for the potentials of the positive and negative electrodes were measured as potentials corresponding to the battery voltage, and this shows that both the potential of the positive electrode and the potential of the negative electrode were measured with high accuracy.

It has thus been found that when the reference electrode having a stainless-steel wire embedded in a solid electrolyte layer and having metallic lithium deposited on the stainless-steel wire by using a lithium source released from the positive electrode active material layer is used, the potentials of the positive and negative electrodes can be measured stably on the basis of the metallic lithium in the reference electrode. Other Embodiments

Although the battery according to the present disclosure has been described based on the embodiment, the modification, and the example above, the present disclosure is not limited to the embodiment, the modification, or the example. The scope of the present disclosure also includes modes built by adding various modifications conceived of by those skilled in the art to the embodiment or the modification and other modes built by combining some of the constituents of the embodiment and the modification, as long as such modes do not depart from the gist of the present disclosure.

For example, although the battery in the embodiment and the modification described above is a single-cell battery including a single positive electrode layer, a single solid electrolyte layer, and a single negative electrode layer, the present disclosure is not limited to this. The battery may be a laminated battery in which single-cell batteries are laminated and electrically connected in series or in parallel.

In addition, for example, although metallic lithium is deposited on the metal wire member by using part of lithium ions released from the positive electrode active material layer as a lithium source in the embodiment and the modification described above, the present disclosure is not limited to this. Lithium ions released from the negative electrode active material layer may be used as a lithium source, or an active material that releases lithium ions serving as a lithium source may be brought into contact with the solid electrolyte layer 30 to use the lithium ions released from the active material.

In addition, for example, although the battery is a lithium-ion battery in the embodiment and the modification described above, the present disclosure is not limited to this. The battery may be a battery using non-lithium ions such as natrium ions or magnesium ions. In that case as well, when metal is deposited on the metal wire member using ions from the positive electrode active material layer as a metal source, the potentials of the positive electrode layer and the negative electrode layer can be measured stably using the reference electrode, as described above.

Moreover, the embodiment and the modification described above may be subjected to various kinds of modification, replacement, addition, omission, and the like within the scope of claims and the scope of its equivalents.

The battery according to the present disclosure can be used for monitoring, designing, development, or the like of electrodes. Also, the battery according to the present disclosure can be used for an electronic device, an electrical appliance, an electrical vehicle, or the like as a battery in which the electrical characteristics of electrodes can be measured.

What is claimed is:

1. A battery comprising:
a positive electrode layer having a positive electrode active material layer containing a positive electrode active material containing a lithium element;
a negative electrode layer;
a solid electrolyte layer located between the positive electrode layer and the negative electrode layer; and
a reference electrode, at least a portion of the reference electrode being embedded in the solid electrolyte layer, wherein
the reference electrode has a metal member constituting at least part of the portion of the reference electrode embedded in the solid electrolyte layer and containing a metal which does not alloy with lithium.

2. The battery according to claim 1, wherein
the metal which does not alloy with lithium is stainless-steel.

3. The battery according to claim 1, wherein
the metal member is a metal wire member.

4. The battery according to claim 1, wherein
the metal member further includes a metal layer coating the metal which does not alloy with lithium and being formed of a metal material which alloys with lithium.

5. The battery according to claim 4, wherein
the metal material contains at least one selected from the group consisting of silver, gold, silicon, aluminum, zinc, cadmium, indium, lead, gallium, bismuth, antimony, tin, and magnesium.

6. The battery according to claim 4, wherein
the metal material contains silver.

7. The battery according to claim 1, wherein
the reference electrode further has metallic lithium coating the metal member.

8. The battery according to claim 7, wherein
an amount of the metallic lithium and an initial charge capacity of the positive electrode active material layer satisfy 100≤(a+b)/a≤1000, where a (mAh) is the amount of the metallic lithium, and b (mAh) is the initial charge capacity of the positive electrode active material layer.

9. The battery according to claim 1, wherein
the metal member is in contact with the solid electrolyte layer.
